(19) United States
(12) Patent Application Publication
(10) Pub. No.: US 2018/0189585 A1
(43) Pub. Date: Jul. 5, 2018

(54) Storage with In-situ Anti-Malware Capabilities

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/784,065

(22) Filed: Oct. 13, 2017

Related U.S. Application Data
(63) Continuation-in-part of application No. 15/452,728, filed on Mar. 7, 2017.

(30) Foreign Application Priority Data
Mar. 7, 2016 (CN) 201610127981.5
Mar. 3, 2017 (CN) 201710122861.0
Mar. 7, 2017 (CN) 201710130887.X
Jun. 18, 2017 (CN) 201710461215.7
Jun. 19, 2017 (CN) 201710461241.X
Oct. 11, 2017 (CN) 201710940898.4

(51) Int. Cl. G06K 9/00; G06F 21/56; G06K 9/62; G11C 13/00; G11C 15/00; G11C 17/10; G11C 17/16; G11C 5/02; G11C 5/06

(52) U.S. Cl. CPC G06K 9/00973; G06F 21/564; G06K 9/62; G11C 13/0002; G11C 15/00; G11C 2213/71; G11C 17/165; G11C 5/025; G11C 5/063; G06F 2221/032; G11C 17/10

(57) ABSTRACT

The present invention discloses a three-dimensional memory (3D-M) with in-situ anti-malware capabilities (3D-M_{AM}). It comprises a plurality of storage-processing units (SPU). Each SPU comprises at least a 3D-M array for storing computer data and a pattern-processing circuit for screening the computer data against a malware pattern. The 3D-M array is stacked above the pattern-processing circuit. Multiple 3D-M_{AM} dice can form a storage card, or a solid-state drive with in-situ anti-malware capabilities.

### CROSS-REFERENCE TO RELATED APPLICATIONS

This application is a continuation-in-part of application “Distributed Pattern Processor Comprising Three-Dimensional Memory”, application Ser. No. 15/452,728, filed Mar. 7, 2017, which claims priorities from Chinese Patent Application No. 201610127981.5, filed Mar. 7, 2016; Chinese Patent Application No. 201710122861.0, filed Mar. 3, 2017; Chinese Patent Application No. 201710130887.X, filed Mar. 7, 2017, in the State Intellectual Property Office of the People's Republic of China (CN).

This application also claims priorities from Chinese Patent Application No. 201710461215.7, filed Jun. 18, 2017; Chinese Patent Application No. 201710461241.X, filed Jun. 19, 2017; Chinese Patent Application No. 201710940898.4, filed Oct. 11, 2017, in the State Intellectual Property Office of the People's Republic of China (CN), the disclosures of which are incorporated herein by references in their entireties.

### BACKGROUND

### 1. Technical Field of the Invention

The present invention relates to the field of integrated circuit, and more particularly to a storage with in-situ anti-malware capabilities.

### 2. Prior Art

Computer security is the protection of computer systems from the theft or damage to their software or information, as well as from disruption or misdirection of the services they provide. This field is of growing importance due to the increasing reliance on computer systems and the Internet, wireless networks such as Bluetooth and Wi-Fi, and the growth of “smart” devices, including smart-phones, televisions and tiny devices as part of the Internet of Things (IoT).

An important aspect of computer security is anti-malware. Malware, short for malicious software, is any software used to disrupt computer operation, gather sensitive information, or gain access to private computer systems. During the anti-malware operation, computer data are screened against malware patterns, which are collectively referred to as a malware database. Unless explicitly stated, the present invention does not differentiate “malware” and “virus”. They are used interchangeably.

The basic anti-malware operations are pattern matching and/or pattern recognition. Pattern matching and pattern recognition are the acts of searching a target pattern (i.e. the pattern to be searched) for the presence of the constituents or variants of a search pattern (i.e. the pattern used for searching). The match usually has to be “exact” for pattern matching, while it could be “likely to a certain degree” for pattern recognition. In the case of computer security, the target pattern is a computer data, while the search pattern is a malware pattern. Unless explicitly stated, the present invention does not differentiate pattern matching and pattern recognition. They are collectively referred to as pattern processing. In addition, search patterns and target patterns are collectively referred to as patterns.

The malware database has become large: the number of malwares has reached hundreds of thousands, soon to millions. U.S. patent application Ser. Nos. 15/29,640 & 15/729,643, both filed Oct. 10, 2017, disclose several three-dimensional (3-D) security processors which can efficiently screen a network packet or a computer data against a large number of malware patterns. The 3-D security processor can act as a gateway of computer and ensure the integrity of the data to be stored into a storage, i.e. they are free of the malware patterns in the malware database.

One scenario the above-mentioned patent applications fail to address is the discovery of a new malware. Once is a new malware is discovered, although the malware database can be instantly updated to ensure the integrity of the data-to-be-stored, the integrity of the existing data in the storage cannot be guaranteed because they may have been infected by this newly-discovered malware long ago. To ensure their integrity, all existing data need to be screened against the newly-discovered malware. This is quite challenging for a conventional computer, whose storage and processor are separated based on the von Neumann architecture. The storage (e.g. hard-disk drive, solid-state drive), containing TBs of existing data, is “dumb”, i.e. without any anti-malware capabilities per se. When a new virus is discovered, all existing data need to be read out from the storage and sent to a processor for malware screening. Because it could take hours just to read out existing data, prior art cannot efficiently screen the existing data when a new malware is discovered.

### Objects and Advantages

It is a principle object of the present invention to enhance computer security.

It is a further object of the present invention to improve the anti-malware efficiency when a new malware is discovered.

It is a further object of the present invention to ensure the integrity of the existing data when a new malware is discovered.

It is a further object of the present invention to provide a storage with in-situ anti-malware capabilities at a reasonable cost.

In accordance with these and other objects of the present invention, the present invention discloses a storage with in-situ anti-malware capabilities.

### SUMMARY OF THE INVENTION

The present invention discloses a storage with in-situ anti-malware capabilities. It is primarily a storage, with anti-malware as its secondary function. Compared with prior art, the preferred storage is “smarter”, i.e. it has an in-situ pattern-processing capabilities. To be more specific, the primary purpose of the preferred storage is to store data, while its secondary purpose is to screen the stored data against at least a malware pattern from an input.

The preferred storage comprises at least a three-dimensional memory (3D-M) die. The 3D-M die is a monolithic integrated circuit comprising a plurality of storage-processing units (SPU). Each SPU comprises a pattern-processing circuit and at least a 3D-M array. The 3D-M array stores computer data, while the pattern-processing circuit screens the computer data against the malware pattern from the input. The 3D-M array is stacked above the pattern-processing circuit and is communicatively coupled with the pattern-processing circuit through a plurality of contact vias. These contact vias are collectively referred to as inter-storage-processor (ISP) connection. Vertically stacked, this type of integration is referred to as 3-D integration. With in-situ anti-malware capabilities, the preferred 3D-M of the present invention is referred to as 3D-M_{AM}.

The 3-D integration of the memory circuit (i.e. 3D-M array) and the processing circuit (i.e. pattern-processing circuit) offers many advantages. Although there is a growing trend to integrate a processing circuit into a memory circuit, the type of integration used by prior art is a two-dimensional (2-D) integration. To be more specific, the processing circuit and the memory circuit are formed side-by-side on the surface of a semiconductor substrate. With the 2-D integration, adding pattern-processing circuits into a memory die would increase the die size, which results in a higher die cost.

In contrast, with the 3-D integration, adding pattern-processing circuits into a 3D-M die will not increase the die size because the pattern-processing circuits are formed under the 3D-M array. It should be noted that most of the substrate area can be used to form the pattern-processing circuits, since the peripheral circuits of the 3D-M array only occupy a small portion of the substrate area. Better yet, because the peripheral circuits of the 3D-M array need to be formed anyway and the pattern-processing circuits can be considered as a byproduct of the peripheral circuits as they are formed at the same time, integrating the pattern-processing circuits into the 3D-M die does not increase its overall manufacturing cost. For a given storage capacity, a “smart” 3D-M_{AM}, which has anti-malware capabilities, costs almost as much as a conventional “dumb” 3D-M, which is just a simple storage.

Besides the cost advantage, the 3-D integration provides a better performance. With the 2-D integration, the connections between the memory circuits and the processing circuits are long (at least tens of microns) and few (tens to hundreds). In comparison, with the 3-D integration, the contact vias between the 3D-M arrays and the pattern-processing circuits are short (microns) and numerous (thousands). As a result, the ISP-connection in the preferred 3D-M_{AM} has a large bandwidth.

Accordingly, the present invention discloses a storage with in-situ anti-malware capabilities, comprising: an input for transferring at least a malware pattern; a semiconductor substrate having transistors thereon; a plurality of storage-processing units (SPU) on said semiconductor substrate, each of said SPUs comprising at least a three-dimensional memory (3D-M) array for storing at least a computer data and a pattern-processing circuit for screening said computer data against said malware pattern; wherein said pattern-processing circuit is formed on said semiconductor substrate; said 3D-M array is stacked above said pattern-processing circuit and communicatively coupled with said pattern-processing circuit by a plurality of contact vias.

As used herein, the phrase “permanent” is used in its broadest sense to mean any long-term storage; the phrase “communicatively coupled” is used in its broadest sense to mean any coupling whereby information may be passed from one element to another element; the expression “to screen a computer data against a malware pattern” means “to detect a malware pattern in a computer data and prevent the malware from damaging a computer system”; the symbol “/” refers to an “and” or “or” relationship, e.g. “text/code” means “text” only, “code” only, or “text” and “code” both; the phrase “data” is used both in both singular and plural forms.

### BRIEF DESCRIPTION OF THE DRAWINGS

FIG. 1 is a circuit block diagram of a preferred 3D-M_{AM};

FIGS. 2A-2C are circuit block diagrams of three preferred storage-processing units (SPU);

FIG. 3 is a cross-sectional view of a preferred SPU comprising at least a three-dimensional writable memory (3D-W) array;

FIG. 4 is a perspective view of a preferred SPU;

FIGS. 5A-5C are substrate layout views of three preferred SPUs.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

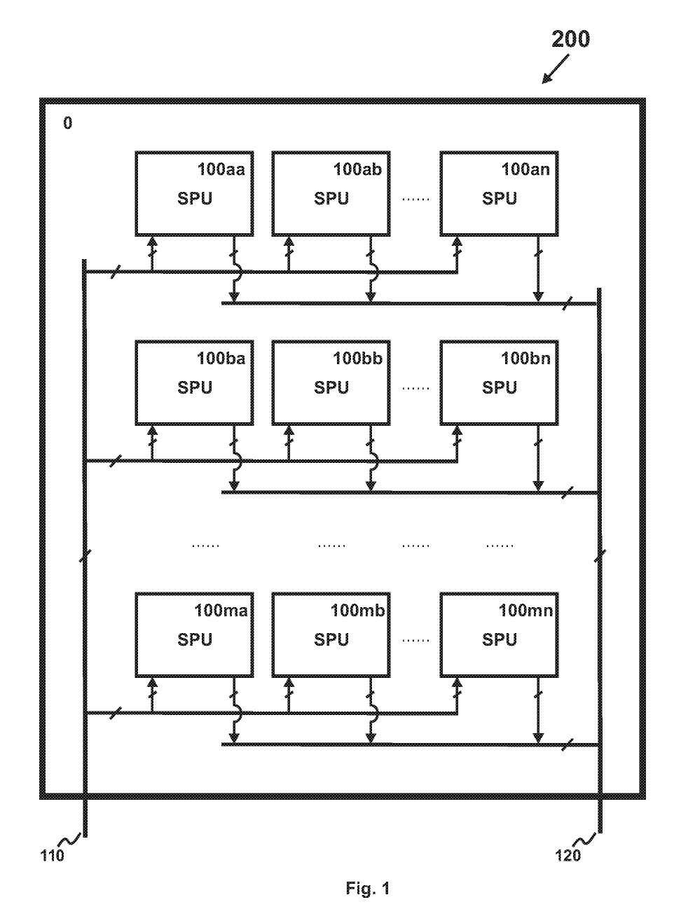

Referring now to FIG. 1, a preferred storage with in-situ anti-malware capabilities is disclosed. It comprises at least a three-dimensional memory (3D-M) with in-situ anti-malware capabilities (3D-M_{AM}) 200. The preferred 3D-M_{AM} 200 not only stores computer data, but also detects malware patterns in situ. It comprises m*n storage-processing units (SPU) 100aa-100mn. Each SPU is commutatively coupled with an input 110 and an output 120. The input 110 transfers at least a malware pattern, while the output 120 transfers at least a result of malware screening.

As used herein, a computer (or, a computer system) includes any device(s) with a processor and a memory. Such devices can range from non-networked standalone devices as simple as calculators, to networked computing devices such as “smart” devices, including smart-phones, televisions and tiny devices as part of the Internet of Things (IoT). The computer data could be a part of a document, a file, a message, a program, or the like. The malware pattern (also known as malware signature, virus pattern, virus signature, etc.) includes the pattern of computer viruses, worms, spam, spywares, ransomewares, sharewares, spywares, trojan horses, keyloggers, backdoors, rootkits, dialers, fraudtools, adwares, browser hijackers, browser helper objects (BHOs), or the like, or any future derivatives or a combination thereof.

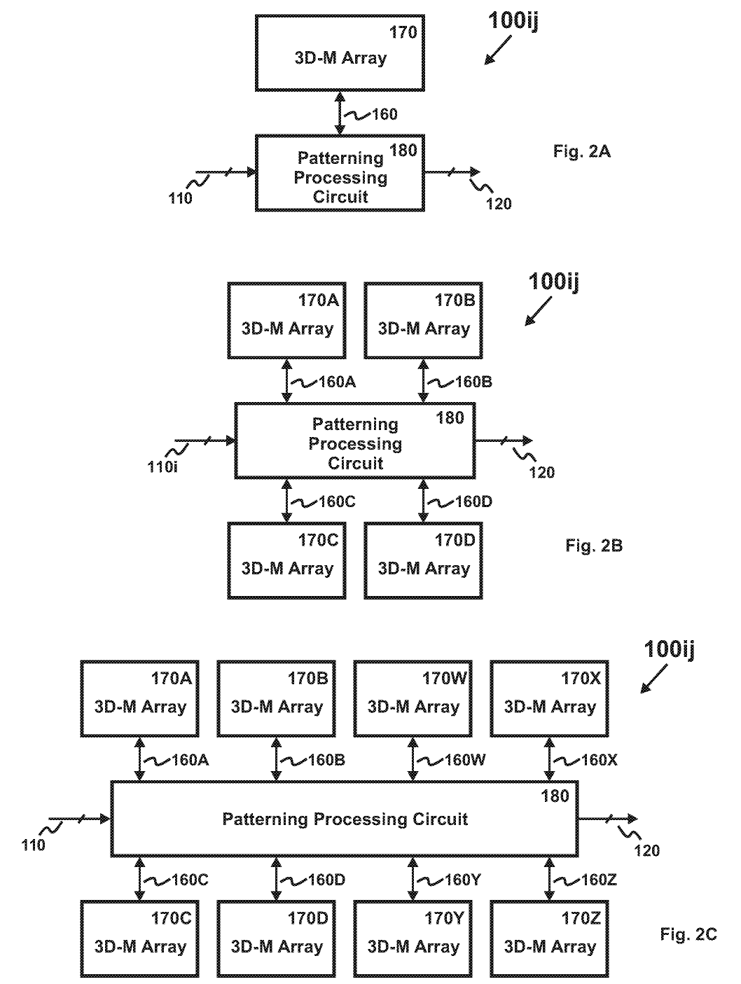

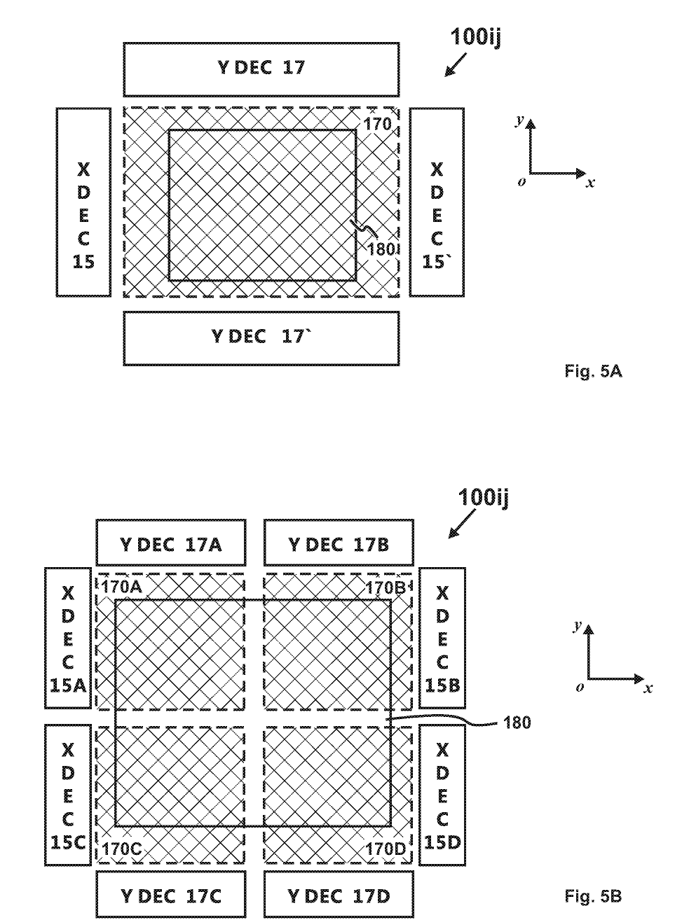

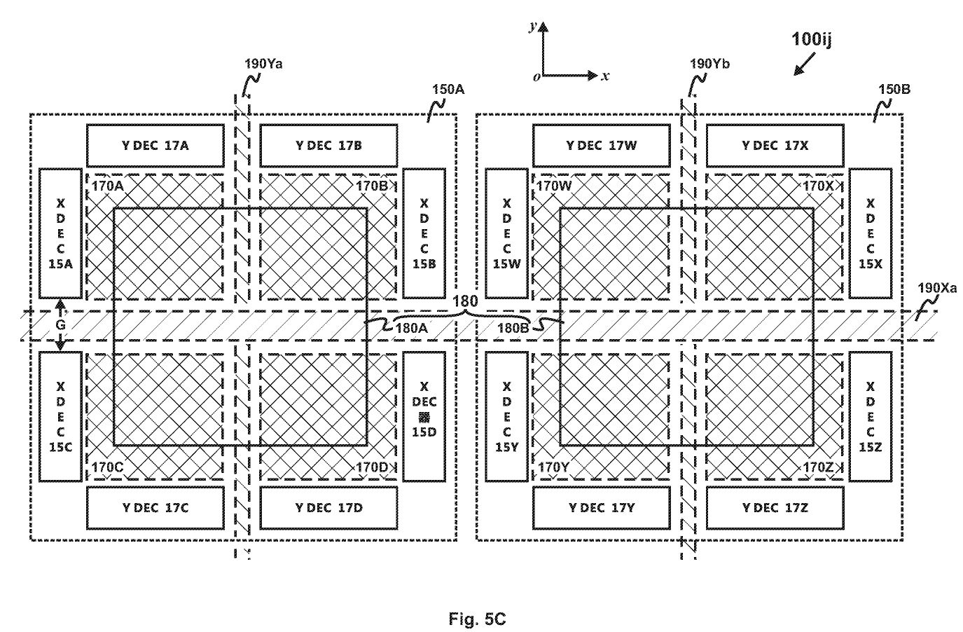

FIGS. 2A-2C discloses three preferred SPUs 100ij. Each SPU 100ji comprises a pattern-processing circuit 180 and at least a 3D-M array 170 (or, 170A-170D, 170W-170Z), which are communicatively coupled through an inter-storage-processor (ISP) connection 160 (or, 160A-160D, 160W-160Z). The 3D-M array 170 stores at least a computer data, which is compared with the malware pattern during the anti-malware operation. In these embodiments, the pattern-processing circuit 180 works with different number of 3D-M arrays. In the first embodiment of FIG. 2A, the pattern-processing circuit 180 works with one 3D-M array 170. In the second embodiment of FIG. 2B, the pattern-processing circuit 180 works with four 3D-M arrays 170A-170D. In the third embodiment of FIG. 2C, the pattern-processing circuit 180 works with eight 3D-M array 170A-170D, 170W-170Z. As will become apparent in FIGS. 5A-5C, the more 3D-M arrays it comprises, a larger footprint and more functions will the SPU 100ij have.

The pattern-processing circuit 180 performs pattern matching and/or pattern recognition. It may take many forms. In one example, since a portion of the malware pattern can be represented by a string of characters, the pattern-processing circuit 180 may comprise a text-matching circuit or a code-matching circuit. The text/code-matching circuits could be implemented by a content-addressable memory (CAM) or a comparator including XOR circuits. In another example, since another portion of the malware pattern can be represented by a regular expression, the pattern-processing circuit 180 can be implemented by finite-state automata (FSA) circuits, which include non-deterministic FSA (NFA) circuits or deterministic FSA (DFA) circuits.

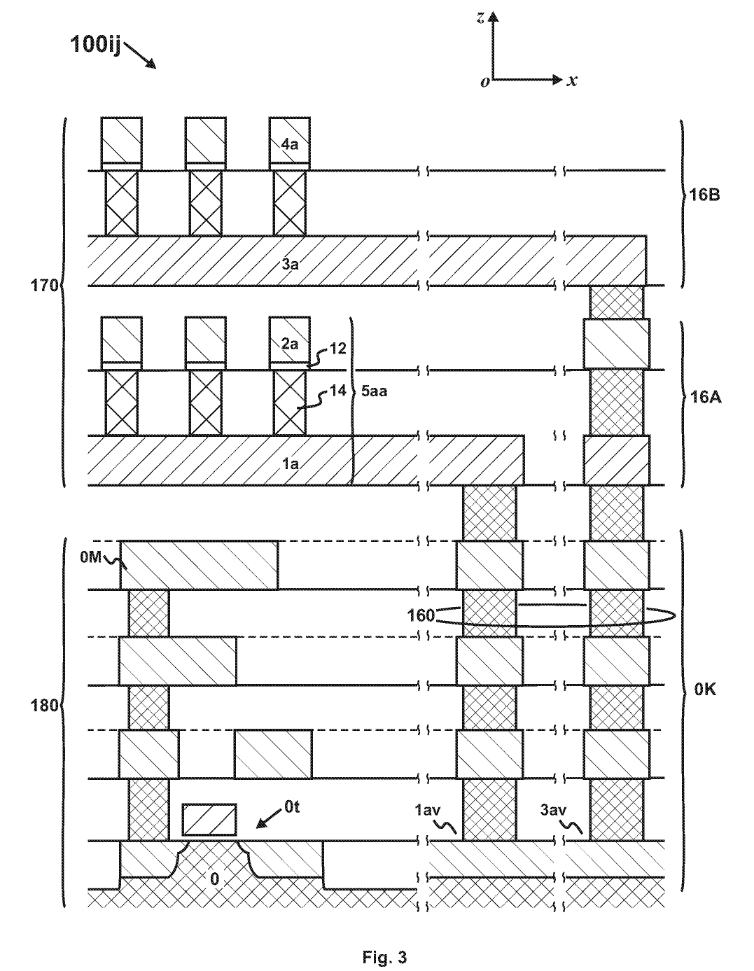

Referring now to FIG. 3, a preferred SPU 100ij comprising at least a 3D-M array is shown. The 3D-M is a monolithic semiconductor memory comprising a plurality of memory cells stacked above and coupled to a semiconductor substrate. A 3D-M array is a collection of the 3D-M cells sharing at least one address line. The most common 3D-M is three-dimensional read-only memory (3D-ROM), which permanently stores information.

Based on the orientation of the memory cells, the 3D-M can be categorized into three-dimensional horizontal memory (3D-M_{H}) and three-dimensional vertical memory (3D-M_{V}). In a 3D-M_{H}, all address lines are horizontal and the memory cells form a plurality of horizontal memory level(s). A well-known 3D-M_{H} is 3D-XPoint. In a 3D-M_{V}, at least one set of the address lines are vertical and the memory cells form a plurality of vertical memory strings. A well-known 3D-M_{V} is 3D-NAND. In general, the 3D-M_{H} (e.g. 3D-XPoint) is faster, while the 3D-M_{V} (e.g. 3D-NAND) is denser.

The 3D-M suitable for computer storage is three-dimensional writable memory (3D-W), whose cells are electrically programmable. Based on the number of programming allowed, a 3D-W can be further categorized into three-dimensional one-time-programmable memory (3D-OTP) and three-dimensional multiple-time-programmable memory (3D-MTP). Types of the 3D-MTP cell include flash-memory cell, memristor, resistive random-access memory (RRAM or ReRAM) cell, phase-change memory (PCM) cell, programmable metallization cell (PMC), conductive-bridging random-access memory (CBRAM) cell, and the like.

The 3D-W comprises a substrate circuit 0K formed on the substrate 0. A first memory level 16A is stacked above the substrate circuit 0K, with a second memory level 16B stacked above the first memory level 16A. The substrate circuit 0K includes the peripheral circuits of the memory levels 16A, 16B, as well as the pattern-processing circuits 180. It comprises transistors 0t and the associated interconnect 0M. Each of the memory levels (e.g. 16A, 16B) comprises a plurality of first address-lines (i.e. y-lines, e.g. 2a, 4a), a plurality of second address-lines (i.e. x-lines, e.g. 1a, 3a) and a plurality of 3D-W cells (e.g. 5aa). The first and second memory levels 16A, 16B are coupled to the substrate circuit 0K through contact vias 1av, 3av, respectively. Coupling the 3D-M array 170 and the pattern-processing circuit 180, the contacts vias 1av, 3av are collectively referred to as inter-storage-processor (ISP) connection 160.

In this preferred embodiment, the 3D-W cell 5aa comprises a programmable layer 12 and a diode layer 14. The programmable layer 12 could be an OTP layer (e.g. an antifuse layer, used for the 3D-OTP) or an MTP layer (e.g. a phase-change layer, used for the 3D-MTP). The diode layer 14 is broadly interpreted as any layer whose resistance at the read voltage is substantially lower than the case when the applied voltage has a magnitude smaller than or polarity opposite to that of the read voltage. The diode could be a semiconductor diode (e.g. p-i-n silicon diode), or a metal-oxide (e.g. TiO₂) diode.

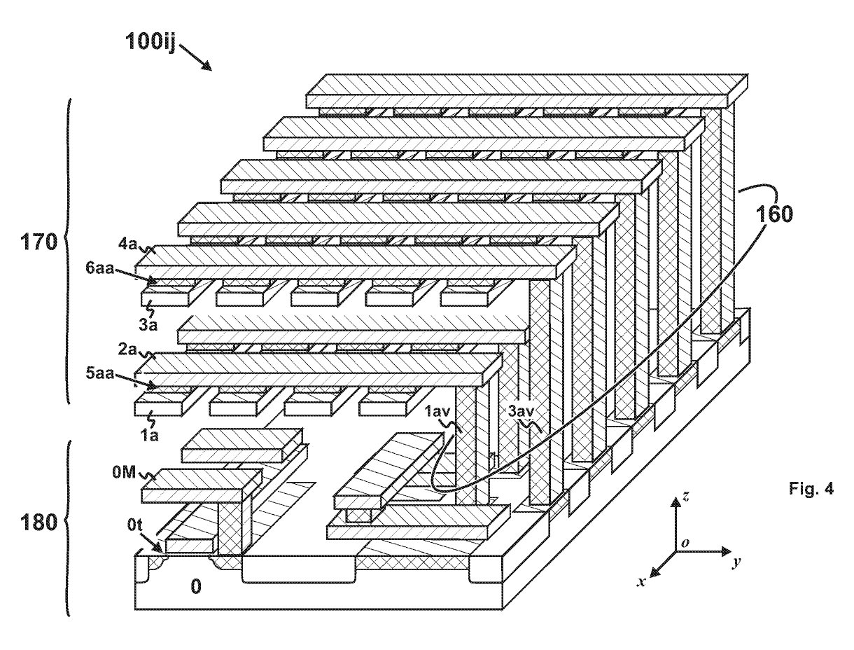

Referring now to FIG. 4, a perspective view of the SPU 100ij is shown. The 3D-M array 170 storing the computer data is stacked above the pattern-processing circuit 180. The pattern-processing circuit 180 is formed on the substrate 0 and is at least partially covered by the 3D-M array 170. With the 3-D integration, the footprint of the SPU 100ij is the larger one of the 3D-M array 170 and the pattern-processing circuit 180. This is significantly smaller than the case of the 2-D integration, where the footprint of an integrated die is the sum of those of the memory circuits and the processing circuits.

Besides a smaller die size, the 3-D integration provides a better performance. With the 2-D integration, the connections between the memory circuits and the processing circuits are long (at least tens of microns) and few (tens to hundreds). In comparison, with the 3-D integration, the contact vias 1av, 3av between the 3D-M arrays 170 and the pattern-processing circuits 180 are short (microns) and numerous (thousands). As a result, the ISP-connection 160 in the preferred 3D-M_{AM} 200 has a large bandwidth.

Referring now to FIGS. 5A-5C, the substrate layout views of three preferred SUPs 100ij are shown. The embodiment of FIG. 5A corresponds to the SPU 100iji of FIG. 2A. The pattern-processing circuit 180 works with one 3D-M array 170. It is fully covered by the 3D-M array 170. The 3D-M array 170 has four peripheral circuits, including x-decoders 15, 15′ and y-decoders 17, 17′. The pattern-processing circuit 180 is bound by these four peripheral circuits. Because the 3D-M array 170 is stacked above the substrate 0, but not formed on the substrate 0, its projection on the substrate 0, not the 3D-P array itself, is shown in the area enclosed by dash line.

The embodiment of FIG. 5B corresponds to the SPU 100ij of FIG. 2B. The pattern-processing circuit 180 works with four 3D-M arrays 170A-170D. Each 3D-M array (e.g. 170) has two peripheral circuits (e.g. x-decoder 15A and y-decoder 17A). Below these four 3D-M arrays 170A-170D, the pattern-processing circuit 180 is formed. Apparently, the pattern-processing circuit 180 of FIG. 5B could be four times as large as that of FIG. 5A. It can perform more complex pattern-processing functions.

The embodiment of FIG. 5C corresponds to the SPU 100ij of FIG. 2C. The pattern-processing circuit 180 works with eight 3D-M arrays 170A-170D, 170W-170Z. These 3D-M arrays are divided into two sets: a first set 150A includes four 3D-M arrays 170A-170D, and a second set 150B includes four 3D-M arrays 170W-170Z. Below the four 3D-M arrays 170A-170D of the first set 150A, a first component 180A of the pattern-processing circuit 180 is formed. Similarly, below the four 3D-M array 170W-170Z of the second set 150B, a second component 1808 of the pattern-processing circuit 180 is formed. In this preferred embodiment, adjacent peripheral circuits (e.g. adjacent x-decoders 15A, 15C, or, adjacent y-decoders 17A, 17B) are separated by physical gaps (e.g. G). These physical gaps allow the formation of the routing channel 190Xa, 190Ya, 190Yb, which provide coupling between different components 180A, 180B, or between different pattern-processing circuits. Apparently, the pattern-processing circuit 180 of FIG. 5C could be eight times as large as that of FIG. 5A. It can perform even more complex pattern-processing functions.

One of the great benefits of the 3D-M_{AM} is that the additional anti-malware capabilities add little or no cost. With the 3-D integration, adding pattern-processing circuits 180 into a 3D-M die will not increase the die size because the pattern-processing circuits 180 are formed under the 3D-M array 170. It should be noted that most of the substrate area 0 can be used to form the pattern-processing circuits 180, since the peripheral circuits (15, 17 . . . ) of the 3D-M array 170 only occupy a small portion of the substrate area 0. Better yet, because the peripheral circuits (15, 17 . . . ) of the 3D-M array 170 need to be formed anyway and the pattern-processing circuits 180 can be considered as a byproduct of the peripheral circuits (15, 17 . . . ) as they are formed at the same time, integrating the pattern-processing circuits 180 into the 3D-M die does not increase its overall manufacturing cost. For a given storage capacity, a “smart” 3D-M_{AM}, which has anti-malware capabilities, costs almost as much as a conventional “dumb” 3D-M, which is just a simple storage.

Like a flash memory, the preferred 3D-M_{AM} of the present invention can be used to form a storage card (e.g. an SD card, a TF card) with in-situ anti-malware capabilities, or a solid-state drive (SSD) with in-situ anti-malware capabilities. To be more specific, a plurality of the preferred 3D-M_{AM} dice 200 can be vertically stacked, and/or horizontally placed inside a package to form a storage card; and, a plurality of storage cards can be placed together and electrically coupled to form an SSD. These preferred storage card and SSD can not only store computer data, but also screen the stored computer data against malwares in situ.

An amazing benefit of the preferred storage card and SSD with in-situ anti-malware capabilities is that their malware-screening time does not increase with the storage capacity. Because each SPU 100ij in each 3D-M_{AM} die 200 has its own pattern-processing circuit 180, this pattern-processing circuit 180 only needs to process the computer data stored in the 3D-M array 170 of this SPU 100ij. As a result, no matter how large is the capacity of the card/SSD, the malware-screening time for the whole card/SSD is similar to that of a single SPU 100ij. This is much faster than a conventional computer system whose malware-screening time increases linearly with the storage capacity.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A three-dimensional memory with in-situ anti-malware capabilities (3D-M_{AM}), comprising:
an input for transferring at least a malware pattern;
a semiconductor substrate having transistors thereon;
a plurality of storage-processing units (SPU) on said semiconductor substrate, each of said SPUs comprising at least a three-dimensional memory (3D-M) array for storing at least a computer data and a pattern-processing circuit for screening said computer data against said malware pattern;
wherein said pattern-processing circuit is formed on said semiconductor substrate;
said 3D-M array is stacked above said pattern-processing circuit and communicatively coupled with said pattern-processing circuit by a plurality of contact vias.

2. The memory according to claim 1, further comprising first and second SPUs formed side-by-side.

3. The memory according to claim 2, wherein both of said first and second SPUs are communicatively coupled with said input.

4. The memory according to claim 2, further comprising an output for transferring at least a result of malware screening.

5. The memory according to claim 4, wherein both of said first and second SPUs are communicatively coupled with said output.

6. The memory according to claim 1, wherein said 3D-M array is three-dimensional writable memory (3D-W) array.

7. The memory according to claim 6, wherein said 3D-W array is a three-dimensional one-time-programmable memory (3D-OTP) array.

8. The memory according to claim 6, wherein said 3D-W array is a three-dimensional multiple-time-programmable memory (3D-MTP) array.

9. The memory according to claim 1, wherein said pattern-processing circuit comprises at least a text-matching circuit.

10. The memory according to claim 1, wherein said pattern-processing circuit comprises at least a code-matching circuit.

11. The memory according to claim 1, wherein said pattern-processing circuit comprises at least a comparator.

12. The memory according to claim 11, wherein said comparator comprises XOR circuits.

13. The memory according to claim 1, wherein said pattern-processing circuit comprises at least a content-addressable memory (CAM).

14. The memory according to claim 1, wherein said pattern-processing circuit comprises at least a finite-state automata (FSA) circuit.

15. The processor according to claim 14, wherein said FAS circuit comprises at least a non-deterministic FSA (NFA) circuit.

16. The processor according to claim 14, wherein said FAS circuit comprises at least a deterministic FSA (DFA) circuit.

17. The memory according to claim 1, wherein said 3D-M array at least partially covers said pattern-processing circuit.

18. The memory according to claim 1, wherein said pattern-processing circuit is covered by at least two 3D-M arrays.

19. The memory according to claim 1, wherein said memory is a portion of a storage card.

20. The memory according to claim 1, wherein said memory is a portion of a solid-state drive.
